(19) United States
(12) Patent Application Publication
(10) Pub. No.: US 2010/0094650 A1
(43) Pub. Date: Apr. 15, 2010

(54) Methods and system for capturing and managing patient consents to prescribed medical procedures

(76) Inventors: Son Nam Tran, Dallas, TX (US); Jacob Verghese, North Richland Hills, TX (US); Regy D. Verghese, Mohnton, PA (US)

Correspondence Address: Navarro Law Office, PC, PO Box 166851, Irving, TX, 75016, US

(21) Appl. No.: 12/584,562

(22) Filed: Sep. 8, 2009

Related U.S. Application Data
(60) Provisional application No. 61/191,145, filed on Sep. 5, 2008.

(51) Int. Cl. G06Q 50/00

(52) U.S. Cl. 705/2

(57) ABSTRACT

A method of capturing patient consents to a prescribed medical procedures. Patient accounts are created on a computerized patient consent management system. The system authenticates a login attempt by a patient and displays a visual representation of a prescribed medical procedure to the patient. The patient consent management system presents at least one consent request input field for accepting a consent input from the patient and stores the consent input as part of the patient account. The patient consent management system presents the consent input to at least one care giver in order to determine if the patient has given consent to the prescribed medical procedure.

### PRIOR PROVISIONAL APPLICATION

This application claims the benefit of filing under 35 U.S.C. §119(e) of previously filed provisional application No. 61/191,145 filed Sep. 5, 2008.

### TECHNICAL FIELD

The present invention relates generally to processing patient medical consent records and related information. More specifically, the invention relates to a system and related processes for managing users and patient consent transactions relating to upcoming and prescribed medical procedures. Still more particularly, the invention provides computerized systems and methods for administrating patient medical consent transactions that allow for the automated management, presentation, security, illustration and history capture of such transactions.

### BACKGROUND OF THE INVENTION

The problems related to obtaining informed medical consent for prescribed medical procedures are well known and documented. Failure to obtain proper consent has become an increasingly common issue in medical negligence litigation. The desire of caretakers and administrators to limit liability can be frustrated by the relative length and complexity of printed forms coupled with the difficulties of presenting and explaining technical aspects of medical procedures while assuring they are fully understood by patients before consent to treatment. Other issues relate to the potential for unforeseen complications, the use of experimental drugs or unproven surgical techniques, the probabilities of failure or repeat complications and followup treatment. Still other complicating factors present when obtaining consent from minors, incompetent or incapacitated individuals or consent received as part of research or via experimental trials.

Practical aspects of verifying a patient's consent history are likewise complicating. Besides the treating physician, other care givers, administrators and staff members may be involved in the administration of consent procedures and related treatments. Ensuring each individual in the treatment circle is taking steps in accordance with appropriate consent guidelines may be difficult. Working with paper documents or unverified computer records can lead to mistakes, oversight and/or confusion while reliance on verbal confirmation from a patient may prove unreliable.

Accordingly, there exists a need for a way of managing patient consent transactions. A means of automating the patient id, medical procedure presentation, and consent verification history processes would provide numerous advantages over the known prior art.

### BRIEF DESCRIPTIONS OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 is a process flow diagram showing a method of capturing consents to prescribed medical procedures according to a first embodiment of the invention;

FIG. 2 is a process flow diagram showing a method of capturing consents to prescribed medical procedures according to a second embodiment of the invention;

FIG. 3 is a high level block diagram for a system of capturing and managing consents to prescribed medical procedures according to the invention;

FIG. 4 shows a screen shot of a graphical user interface for displaying visual representations of prescribed medical procedures to patient users according to one embodiment of the invention;

FIG. 5 shows a screen shot of a graphical user interface for displaying patient profile information according to one embodiment of the invention;

FIG. 6 is a process flow diagram for a method of creating a patient account according to one embodiment of the invention;

FIG. 7 shows a screen shot of a graphical user interface for scheduling patients for procedures and tracking their consents;

FIG. 8 shows a screen shot of a graphical user interface presenting a visual representation of a medical procedure; and

FIG. 9 shows a screen shot of a graphical user interface for capturing a patient consent to a prescribed medical procedure.

### DETAILED DESCRIPTION

The particular values, implementations, and configurations discussed in these non-limiting examples can be varied and are cited merely to illustrate at least one embodiment and are not intended to limit the scope of the invention thereof.

The present invention comprises processes and a related system for capturing and managing a patient's consent to a prescribed medical procedure. With the present invention, a care giver (such as a doctor, administrator, nurse and hospital staff as well as others involved in providing health care services) can obtain the appropriate consents to prescribed medical procedures and maintain a transcript of patient consent transactions to determine what aspects of a particular procedure a patient received information about and understood as well as any questions or concerns a patient may have regarding a procedure permitting followup consultation between care giver and patient prior to obtaining a final and informed consent from the patient.

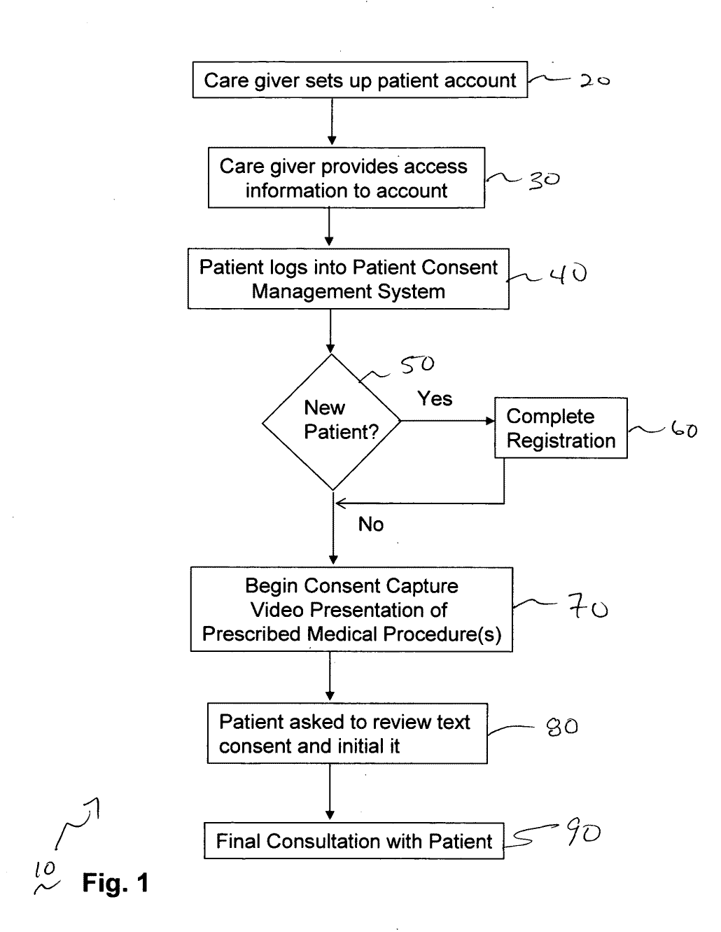

To better understand the inventive aspects of the present invention, reference is made first to FIG. 1, which is a process flow diagram for a method, denoted generally as 10, of capturing a consent to a prescribed medical according to one embodiment of the invention. Process (the words “process” or “method” may be used interchangeably throughout) 10 begins at step 20 when a care giver (the terms “care giver”, “doctor”, “nurse”, “administrator”, “staff”, and other common references to those involved in the delivery of health care services shall be used interchangeably throughout) sets up a patient account. Step 20 may involve the care giver logging into a system for capturing a patient's consent to a prescribed medical procedure (also referred to as “system” throughout) as described herein and scheduling a patient for a procedure. The scheduling of a patient may be accomplished using a simple user interface that shows a list of patients already scheduled and provides access to a scheduling function for new patients.

Step 20 may further involve other standard tasks which may be necessary to facilitate use of a system for capturing a patient's consent. For example, the care giver may need to create a new patient account including the patient's name, primary doctor, condition, date of birth, contact information, etc. . . . Alternatively, some of this information may be provided by the patient upon completion of a registration process which the patient performs when first accessing the system. In any event, step 20 schedules the patient for a prescribed medical procedure(s) and for obtaining the patient's consent to the procedure(s) as selected by the care giver. Furthermore, step 20 may involve the creation of a user name and password to allow the patient user to initially login to the system. The user name and password may be assigned on a temporary basis permitting the patient user to change these parameters and ensuring subsequent secure login to the system. Next, at step 30, the care giver provides the system access information (user name and password, for example) to the patient allowing access to the system and the account setup in step 20.

Process flow is directed to step 40 wherein the patient user of the system logs into the system for the first time. At step 50, the system determines if this is a new patient and, if so, may direct the patient user to registration step 60. As discussed above, registration step 60 may involve collecting and storing a plurality of patient specific identification, contact and medical history information of the type typically associated with the provision of health care service. Once registration step 60 is complete process flow is directed to consent capture step 70.

It is possible the patient user is not a new patient such that his or her registration and account information has already been entered and stored in the system. This may be the case where the patient has been scheduled for prior procedures and consent is needed for a new and upcoming procedure. As such, process flow is directed to step 70 directly from new patient query step 50.

An essential aspect of a system for capturing consents to prescribed medical procedures according to the invention is the presentation of information relating to a scheduled medical procedure in a format that is more readily and easily understood by a patient user of the system. Thus, at step 70, a video representation of a prescribed medical procedure may be displayed to the patient user to illustrate some of the underlying aspects of a given procedure. The video shown at step 70 may be divided into a sequence of video clips with explanatory text and/or audio accompanying the video presentation. A navigation control bar or similar control means may be provided to the patient user in order to allow him or her the ability to stop, rewind, replay or pause the video or clips. As explained in more detail below, a transcript of the information being presented to the patient user and his/her response during the presentation may be created and stored as part of the patient's consent history and/or patient account.

Once the video presentation of the scheduled medical procedure has been viewed by the patient user of the system, the patient is asked to provide his or her consent, step 80, to the procedure (or procedures). Consent step 80 may be accomplished in a variety of ways. For example, a text message containing language that makes clear the patient has viewed and understood what was involved in a particular procedure and that he or her agrees to receive the procedure may be displayed on the system screen. The patient may be provided with a checkbox or drop-down menu options where he or she checks a “consent” box or selects a consent response from a list of options. Alternatively, the patient user may be provided with a text box where he or she can type in a standard consent message or, if applicable, followup questions and/or concerns the patient may have regarding a prescribed procedure.

Another form of consent may involve a video recording of a patient giving his or her consent to a prescribed procedure. For example, a system according to the invention can be outfitted with a video recording such as a web camera or digital cam device, and used to record a small video of the patient user giving consent. The patient user can read a standard consent message provided to him or her by the system at the appropriate time or, alternatively, the system may generate verbal prompts to the patient requesting consent to the procedure in whole or to specific aspects of the procedure in piece meal fashion. In any event, it is contemplated that the specific manner in which the patient is asked to review and provide consent, step 80, may take different forms and that the specific format of capturing a patient's consent to prescribed medical procedures shall be left to the discretion of the system administrator, care giver or other high level user of the system.

Finally, at step 90 a final consultation with the patient user can occur and may involve answering any concerns or questions which the patient may have regarding a particular procedure. It is contemplated, therefore, that step 90 is an optional step of the process 10 depending on the patient user, the procedure or procedures involved, the relationship between a patient and his/her care giver as well as other factors. Final consultation step 90 can precede getting a final consent from the patient and may involve, for example, answering any questions the patient may have about a procedure.

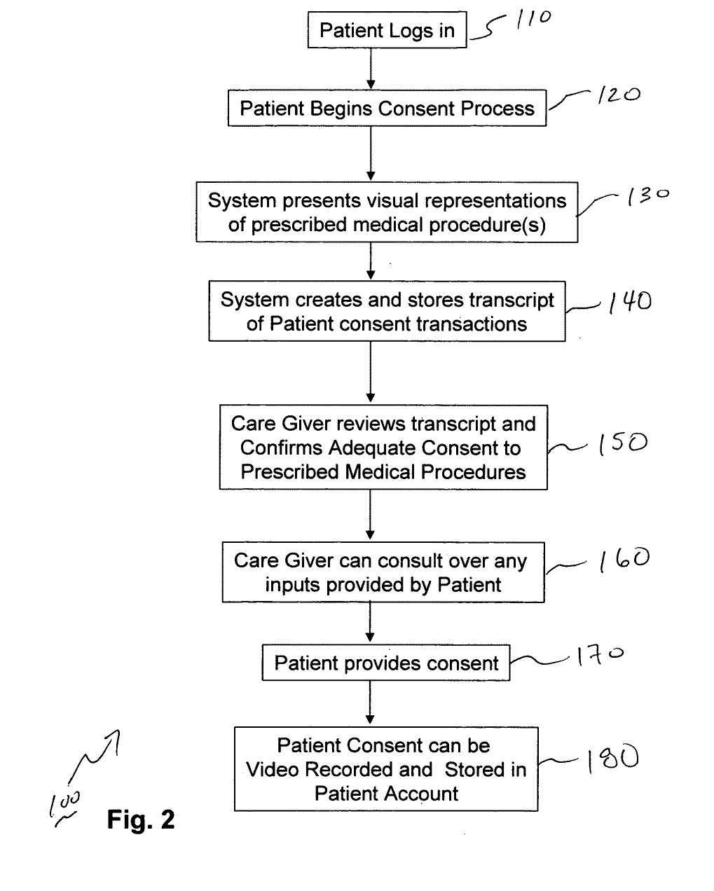

Referring now to FIG. 2, therein is shown a process flow diagram for a method, denoted generally as 100, of capturing a patient's consent to a prescribed medical procedure. Process 100 begins at step 110 wherein a patient user logs into the a system according to the invention. Then, at step 120, the patient begins the consent process wherein the system presents visual representations of one or more prescribed medical procedures, step 130. It should be understood that a patient user has typically been scheduled for a procedure by an authorized care giver so that consent step 120 and visual presentation step 130 are presented to a patient as part of an overall attempt by a care giver to capture a consent to a specific and upcoming procedure.

As indicated in FIG. 2, and specifically at step 140, the system creates and stores a transcript of patient consent transactions that may become part of the patient user's account. This allows users of the system to maintain a history of the information presented to the patient user and to record the patient's responses or inputs to the information. For example, according to one embodiment the patient user is provided with input text fields where he or she can enter any questions or concerns (referred to as “input”) about a procedure. Such input, if any, may be recorded by the system as part of the patient's transcript of consent transactions and become part of the patient's account. If the patient user has entered any inputs, the care giver reviews the patient's consent transcript, step 150, to confirm that adequate consent is received from the patient and then, if necessary, consult with the patient to go over any concerns or questions the patient may have, step 160.

Next, at step 170, the patient user provides consent to the prescribed procedure(s) which can be provided by the patient in various forms and captured by the system so the patient's consent becomes part of his/her consent transcript and patient account. Consents may be stored as a single consent to the procedure in whole, as a series of individual consents to specific aspects of a procedure or in any other format which a care giver determines is adequate. Also, the patient consent can be video recorded (step 180) and stored as part of the patient's consent transcript.

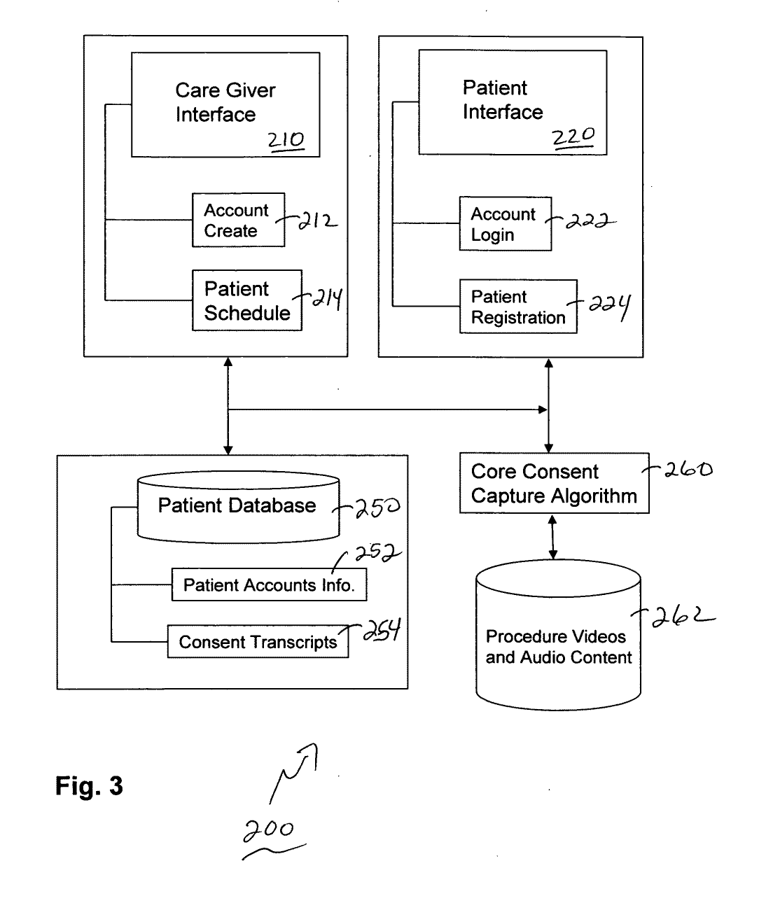

Referring to FIG. 3, a high level block diagram for a patient consent management system, denoted generally as 200, according to one embodiment of the invention is shown. System 200 comprises a first interface 210 from which a care giver can manage various patient related consent transactions. For example, from user interface 210, a care giver can create patient accounts 212 and schedule patients 214 for prescribed medical procedures so that they are able to track patients and their consent status. Likewise, a second interface 220 is provided for patient users of the system 200 which allows patients to login to the system 222 to access the system 200 for entering registration information 224.

As shown, first interface 210 and second interface 220 may be operably linked to a patient database 250 which may be used to store patient account information 252 and patient consent transcripts 254 among other patient specific data. In addition, first interface 210, second interface 220 and patient database 250 may be operably linked to core consent capture algorithm 260 which may comprise the essential software routines and instructions necessary to achieve the various functions of a system for managing patients consents, such as such as system 200, as herein described. It should be understood that the invention does not contemplate any specific type of software implementation nor is it limited by a specific embodiment as those skilled in the art will readily appreciate the many ways in which a patient consent management program according to the invention may be implemented using well known techniques in the software arts.

The core consent capture algorithm 260 has access to a database of procedures videos and other content 262 required to provide a visual representation of prescribed procedures. The content of database 262 may be altered by a system administrator (not shown) from time to time in order to improve the visual representation, to add new procedures to the database or to update procedures as medical practices change over time. In general, no specific implementation of the consent capture algorithm 260 is required although it is envisioned that a suitable consent capture algorithm could support at least the following program modules:
Visual Representation Module: software instructions to retrieve and display appropriate video and audio relating to a patient's prescribed medical procedures. This module may also present video as a sequence of videos.
Text Overlays Module: software instructions that retrieve and display textual content to assist patient understanding of prescribed medical procedures;
Consent Input Request Module: software instructions that causes a display of patient user input fields for capturing responses, text input and selections by user and to store such input for retrieval and review by care giver.
Consent Transcript Module: software instructions to record and save patient user consent transactions into a history file that shows what information was shown to a patient user and what input was received from a patient user as a function of time.
Consent Statement Module: software instruction to cause system 200 to display consent requests to patient users and to record consent inputs from patient users. This module may also record a video/audio consent by a patient user. Consent may take various forms and may be assisted by care givers after consultation or may comprise printing of hard copy consent form which is then signed by a patient user, or may comprise partial automated consent and partial paper consent. Any suitable consent mechanism may be fashioned according to various embodiments.
Account Setup Module: software instructions to allow care givers to create and maintain patient accounts including account access such as user names and passwords. This module may also include program instructions which permit system 200 to transmit messages to patient users over the Internet and such messages may include account access information.

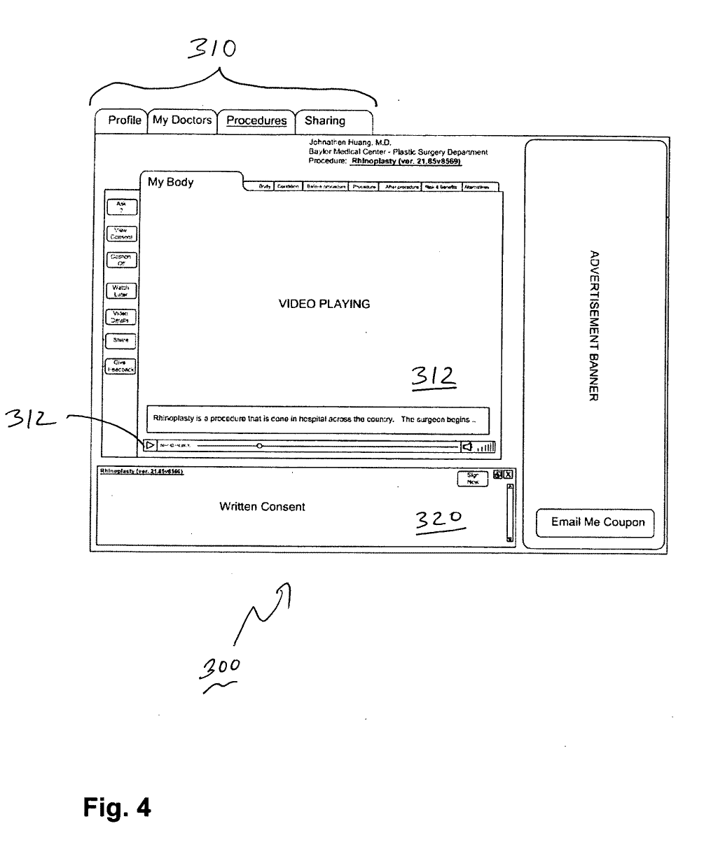

Therefore, the present invention provides methods and a related system for capturing consents to prescribed medical procedures and for managing the process of obtaining consents. The specific implementations of such processes and a system according to the invention may take various forms. In one specific embodiment, the patient user successfully logs into a system, such as system 200, and is presented with a screen containing a video player with navigation functions and an area where he/she can enter consent input. An example of this is shown in FIG. 4 which is a graphical user interface of an example medical procedure representation screen 300 according to one example.

As shown on screen 300, the patient user may be presented with a user interface providing health care option tabs 310 which as shown in the example embodiment allow the user a way to navigate through profile, doctor, procedure and sharing feature (the procedure feature is actually shown in FIG. 4). A large portion of screen 300 comprises a video display 312 which allows for video representations of prescribed and scheduled medical procedures to be displayed. Of course, other configurations will become apparent to those of ordinary skill in the art. As shown, video display 312 includes navigation controls 314 which allow a patient user to control the video playback features. Screen 300 also comprises a input area 320 which allows a patient user to enter input, such as a written consent or followup questions or concerns, which the system can store for followup by care givers.

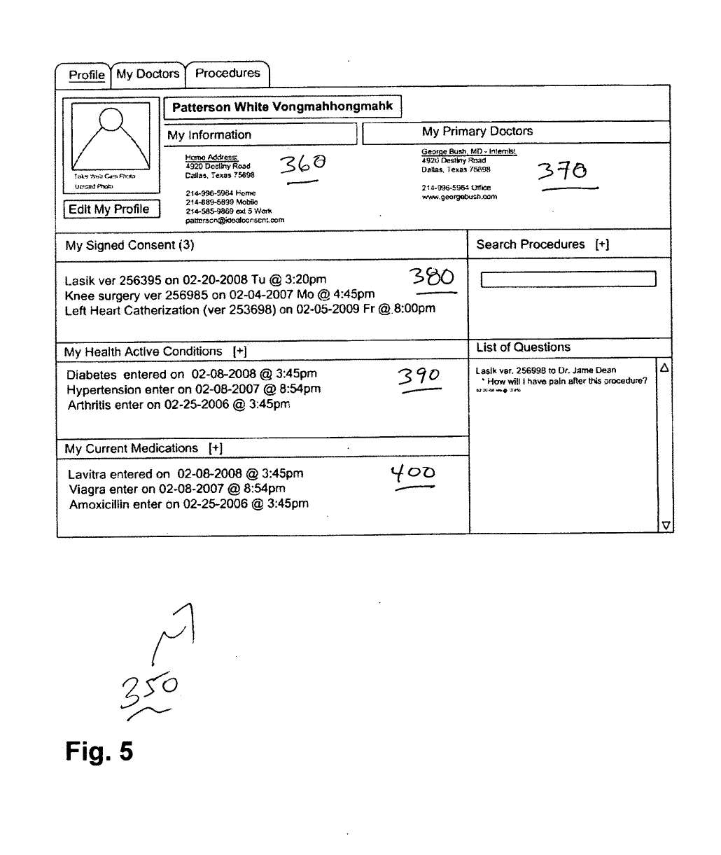

Referring to FIG. 5, an example patient user profile screen 350 is shown according to one embodiment. Profile screen 350 includes basic patient information 360 such as a patient's address and telephone number along with care giver information 370. In addition, profile screen 350 shows prescribed procedures 380 for the patient user and other health related information for the patient such as health active conditions 390 and current medications 400. It will be readily apparent to those skilled in the art that profile screen 350 is no more than a single potential arrangement and display of a patient's medical profile and that numerous other configurations are possible all within the scope of the present invention.

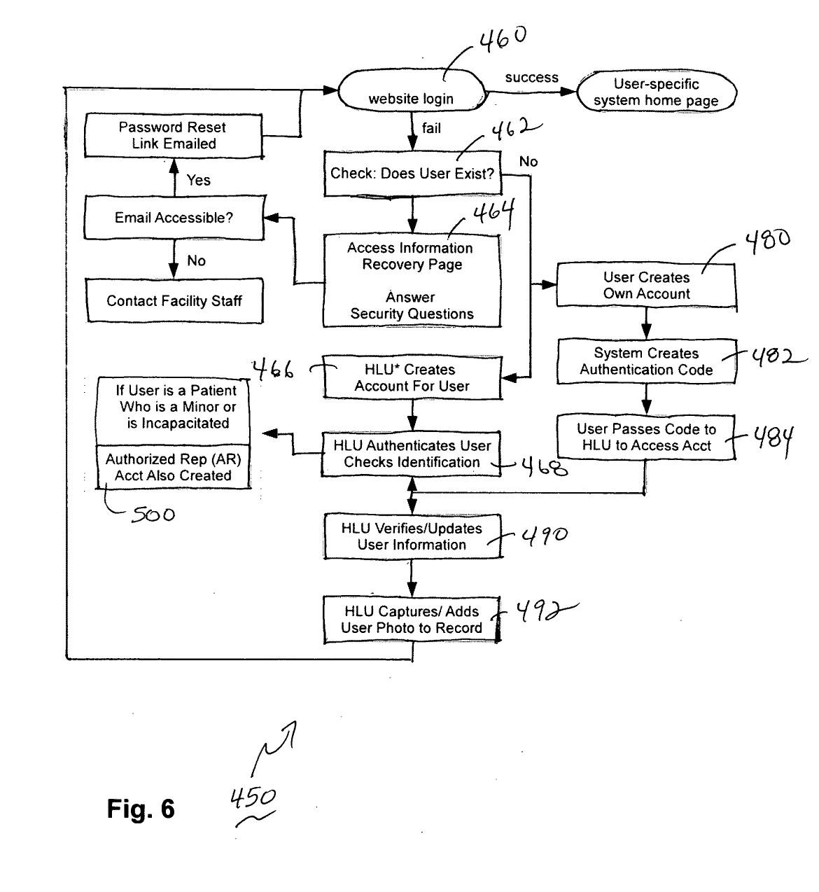

Referring to FIG. 6, a process flow diagram for a method of setting up an account for a patient user is shown and denoted generally as 450. For purposes herein, a system administrator shall be referred to as Higher Level Users (HLU). It should be understood that a HLU may be a care giver or another system user having administrative function responsibility over a system, such as system 200, for managing patient consents. Thus, the HLU would typically be assigned an administration level above the new patient user. Patient information can be entered either by the patient, the patient's Authorized Representative (AR) or Facility Staff (FS). All confidential information may be encrypted according to Health Insurance Portability and Accountability Act (HIPAA). Each user may be restricted to having only one account.

After login, step 460, the HLU can first search if a record already exists for the user, step 462. If a record does not exist, the HLU may proceed to create an account for the new user, step 466. Then, at step 468, the system may automatically check the data as it is entered for possible duplication. Data may be checked based on unique identifiers entered such as drivers license number, passport number, social security number, etc. Alternatively, the HLU may manually authenticate a user by verifying ID and/or taking picture(s) of user to include in user record. A set of security questions and answers may also be setup to aid in recovering lost access information, step 464.

The process 450 for setting up a user account may also involve a patient user creating his/her own account, step 480. For a user to create an account for logging in by themselves, they may be required to have an email address to facilitate recovery of lost access information, step 464. A patient user may create an account on an application website that hosts the system 200. Before a new account can be opened, the user may be asked if they have accessed the system before. If they have, they may be forced to use the existing account. If they have lost their access information, they can recover it. As the user information is entered, the system may automatically check if a duplicate record exists, based on unique identifiers entered such as drivers license number, passport number, social security number, etc.

A set of security questions and answers may be setup at this point to aid in recovering lost access information, step 464. A user may enter as much information as possible from home or kiosk/portable device located at a provider facility. If the user is a patient/AR, the doctor and the facility may be authorized here to view patient record. The system may then issue an authorization code, step 482, which the user gives to the HLU, step 484. The HLU may then pull up the user account using the authorization code (preferably) or social security number, name and address or other identifiable information, step 468. Next, the HLU may then verify and update patient consent information as needed, step 490. The HLU may also take a picture of the user to include in the user account, step 492.

At step 500, if the user is a patient who is a minor or is incapacitated, an Authorized Representative (AR) may be provided access to the system to enter and access the patient record. For this, a separate account may be created for the AR which is then connected to the patient record. Thus, even though more than one person can be an AR for a patient, only one AR at a time may be allowed to represent the patient as the primary AR. As such, only the primary AR may be allowed access to the patient record. If the primary AR will no longer represent the patient, another AR account may be connected to the patient record as the primary AR.

If a patient user or AR would like to access the system from home, the patient or AR may be asked to enter a user name and password when the account is created. Alternatively, if the patient or AR does not want to have remote access, they may not be required to create or remember any access information. Alternatively, they may be authenticated directly at the facility at the time of the consent.

As part of implementing a patient consent management system, such as system 200, it may be necessary to define users groups which are given different levels of rights and permissions to access create, modify patient records, schedule procedures and perform other operational aspects of the system 200. The following categories of user access groups may be employed according to one embodiment of the invention. It should be understood that different access groups may be defined and that various other categories may be employed according to alternate embodiments:
Application Administrators: Application Administrators may be given complete access to the application and the database. Confidential patient information in the database may be encrypted so that even Application Administrators will be unable to view it.
Facility Administrators: Facility Administrators are people who have access to all information pertaining to a specific facility. They may also have permissions to create all levels of users in the facility.
Providers: Providers are doctors, nurses and other medical professionals who perform billable medical services. Providers may be authorized by the patients to access the patient record.

Facility Staff (FS): Facility Staff are administrative office staff of a facility that manage patient information. They may have selective access to patient records such as name, address, contact information etc. They may also have the access necessary to create the initial patient record which may include information about previous health conditions, allergies etc.
Patient/Authorized Representative (AR): Patients or the primary Authorized Representative (AR) may have complete access to patient records, including all consents that relate to the patient record.

Other aspects of the disclosed methods for capturing consents and of a related system for managing patient consents according to the invention:
User Login: This process may be applied to all levels of access to the application, including certified facility administrators, FS, providers and patients/AR. Users may gain access to their record from a starting point on the application home page on the Internet, for example. Users may use their user name and password to login. Access point analytics may be recorded including IP, time of access, operating system, browser, etc.
Recovering Lost Access Information: If the access information is lost, the user may click on a Recover User Name and Password link at the login page to start the recovery process. This may be accomplished by access to an Access Information Recovery Module on the application. On the Access Information Recovery Page, they will be asked to answer previously setup security questions. If the questions are answered correctly, a security code or secure link may be e-mailed to the user's email address. Using that security code or link, a user will be able to reset their password. If the user no longer has access to their email, they may be required to go to the facility they are associated with to authenticate themselves and update their e-mail address.
Access Logging: All access to the patient record may be logged. The patient/AR as well as Facility Administrators may be able to view the Access logs.
1. Patient Consent Setup. FS may log in to IC on office PC.
2. FS may select patient record and assign the prescribed procedure(s) to it.
3. System may locate all consents associated with the assigned procedure(s).
4. FS may assign doctors and facilities for each procedure.
5. FS may take a Consent View/Capture Device (CVCD) to the patient/AR (or brings patient/AR to it) and to the start page of the consent. FS may also set the best viewing angle for the patient and aim the camera correctly at the patient.
The Consent Process:
1. Patient/AR Logs In. The patient/AR may login by themselves or can be logged in by an FS.
2. Patient/AR Selects the First Procedure. The patient/AR may select the first procedure from a list of procedures assigned to the patient.
3. Patient/AR will grant Access to Doctor(s). The doctors and the accompanying health care team may need to have access to the patient record as well as consent. This is where the patient may authorize them to access that information. The team would have already been assigned to the procedure by an FS. So all the patient needs to do here is to authorize access to the team associated with the procedure. Once the access is granted and the procedure has been performed, access may no longer be revoked.
4. Patient/AR Views Consent. Each consent may be broken up into multiple clips for easy viewing.
5. Consent. The first clip may describe the benefits of the IC method of educating the patient and obtaining consent, demonstrate the various sections, show how the patient can interact with the system, etc.
6. Patient will view each clip in a sequence. Any clip may be replayed, rewound, forwarded, paused etc.
7. If the patient/AR has any questions, they may click on “Ask a Question” button to open a window where they can type in the question.
8. A text version of the consent may also accompany each clip in a window right below the video.
9. Doctor may then review consent transcript after the consent has been completed. A doctor may review the transcript of the patient/AR's interaction with the consent. He/she may also answer the questions the patient/AR has submitted.
10. Patient Confirms Questions Answered Satisfactorily. The next step may ask the patient/AR if all the questions that the patient/AR has submitted with were answered to their satisfaction.
11. Patient/AR Signs Consent. Once the patient/AR confirms that their questions have been answered satisfactorily, they may be presented with a signature pad on the touchscreen.
12. Patient/AR Records Consent Statement on Video The final clip may make a series of statements that summarize the various sections of the consent. After each statement the narrator may ask if the patient/AR understands what has been explained and whether the patient/AR recognizes the risks and benefits. The patient/AR may be required to respond to each request.
13. Conclusion. The narrator may thank the patient concluding the particular consent transaction. The patient/AR may then be taken to the next consent in the procedure or the next procedure.

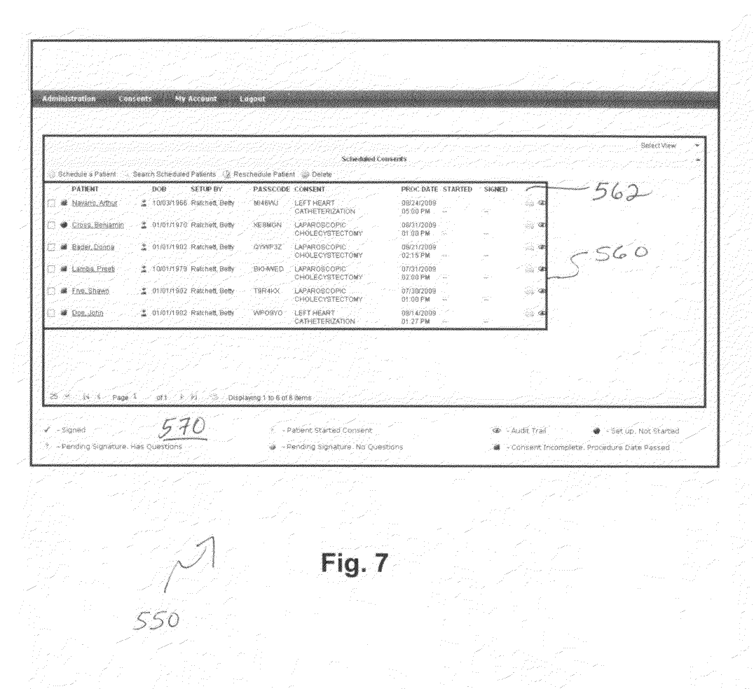

FIGS. 7, 8, and 9 are sample graphical user interface screens which illustrate various aspects of a system, like system 200, for capturing and managing patient consents to prescribed medical procedures. In FIG. 7, a patient scheduling screen 550 is shown providing a view to a patient list 560 which provides a plurality of patient information 562 for each patient scheduled for a prescribed medical procedure. The information 562 can include data such as a patient's name, date of birth, pass code, consent status, procedure date, whether the consent process has begun and if the patient has provided consent. A legend box 570 is provided giving the user a meaning of the various indicators on a patient information 562. A patient scheduling screen, such as screen 550, provides an efficient way for a HLU to schedule patients for procedures and to monitor their consent status.

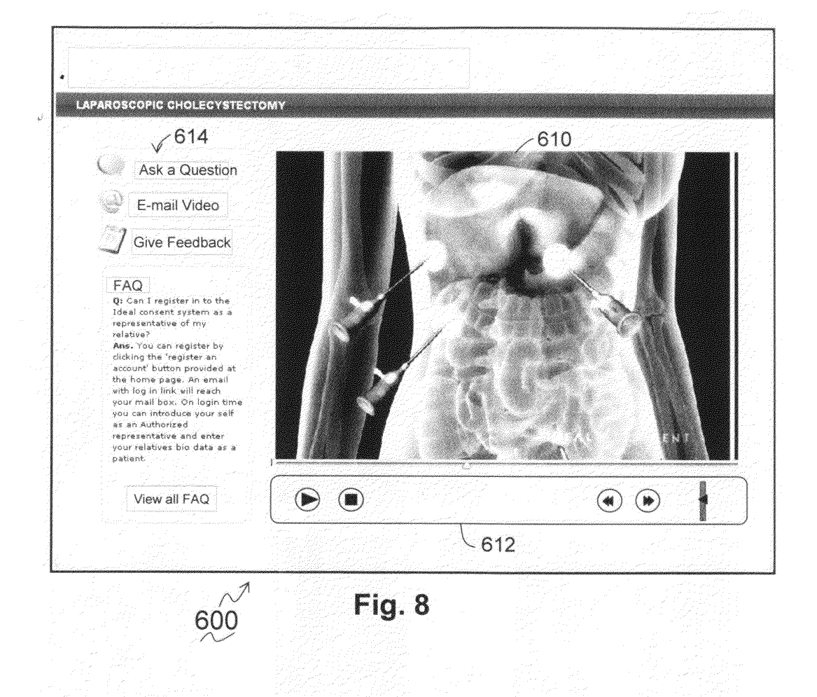

FIG. 8 is a sample visual representation screen 600 in which a video 610 of a prescribed medical procedure (in this case a laparoscopic cholecystectomy) can be presented to a patient user of the system. Screen 600 includes a navigation bar 612 and various user selectable options 614 which allow the patient user to control various aspects of the consent capture process as he/her is viewing the video 610. Of course since a screen, like visual representation screen 600, can be accessed over the Internet from just about any computer terminal, the information provided to a patient user from screen 600 provide an efficient way to provide the details of medical procedures to patients at their leisure and more effectively that current paper based systems that rely on complicated and lengthy forms to obtain consent from a patient.

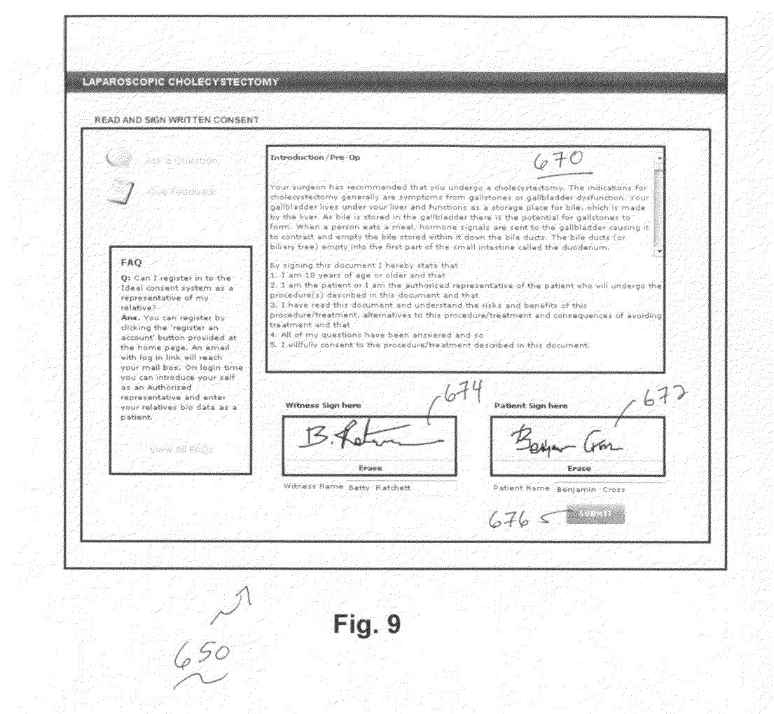

FIG. 9 is a consent capture screen 650 illustrating one way in which a system, such as system 200, can be used to captures a patient's consent to prescribed medical procedures. As shown, consent capture screen 650 includes an explanatory text screen 670 which provides a text messages to the patient user. Also appearing on screen 650 are a patient signature box 672 and a witness signature box 674 in which a patient and a witness (a HLU or care giver, for example) can enter their signatures as evidence that a consent from a patient was captured. Once a patient's consent is provided the patient can hit the “SUBMIT” button 676 and the patient's consent can be captured and stored in the patient's electronic patient account.

Of course, it will be readily apparent to those skilled in the art that other forms of interfacing with HLUs, care givers and patient users can be utilized providing a similar means of scheduling patients for medical procedures, providing procedure information and capturing and storing a patient's consent. As such, FIGS. 7, 8 and 9 are provided only as examples and should not be interpreted in a way to limit the scope of the present invention.

In general it should be understood that modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method of capturing a consent to a prescribed medical procedure comprising the steps of:
establishing a patient account on a computerized patient consent management system;
the patient consent management system authenticating a login attempt to said patient account by a patient;
the patient consent management system displaying a visual representation of a prescribed medical procedure to said patient;
the patient consent management system presenting at least one consent request input field for accepting a consent input from said patient;
the patient consent management system storing said consent input as part of said patient account; and
the patient consent management system presenting said consent input to at least one care giver in order to determine if said patient has given consent to said prescribed medical procedure.

2. The method of capturing a consent according to claim 1 further comprising the steps of:
the patient consent management system presenting at least one patient followup question input field to said patient; and
the patient consent management system storing a followup question input entered by said patient into said followup question input field; and
the patient consent management system presenting said followup question input to a care giver to said patient so that a care giver can consult with said patient regarding a question said patient may have about said prescribed medical procedure.

3. The method of capturing a consent according to claim 1 wherein said step of displaying a visual representation of a prescribed medical procedure further comprises the step of the patient consent management system displaying a sequence of video clips to illustrate said prescribed medical procedure.

4. The method of capturing a consent according to claim 3 further comprising the step of presenting corresponding text related to said prescribed medical procedure.

5. The method of capturing a consent according to claim 3 further comprising the step of the patient consent management system maintaining a transcript indicating which video clips in the sequence were viewed and which ones were skipped by said patient.

6. The method of capturing a consent according to claim 1 wherein further comprising the step of the patient consent management system recording a video showing said patient's consent to said prescribed medical procedure.

7. The method of capturing a consent according to claim 1 wherein said step of presenting at least one consent request input field further comprises the step of presenting a statement field indicating the patient has witnessed and understood the visual representation of the prescribed medical procedure.

8. The method of capturing a consent according to claim 1 further comprising the transmitting a message to said patient after said patient account is established, said message including a plurality of information that allow said patient to access said patient consent management system over the Internet.

9. The method of capturing a consent according to claim 1 further comprising the step of said patient consent management system presenting one or more patient registration information fields for obtaining patient related registration data from said patient.

10. Using a computerized patient consent management system, a method of capturing consents to prescribed medical procedures comprising the steps of:
the patient consent management system accepting scheduling requests from care givers for prescribed medical procedures;
the patient consent management system processing login attempts from patients who are scheduled to receive prescribed medical procedures;
for each patient who has been scheduled for a prescribed medical procedure and who has successfully logged into the patient consent management system, the patient consent management system displaying a visual representation of a prescribed medical procedure to said patient;
the patient consent management system presenting at least one consent request input field for accepting a consent input from said patient;
the patient consent management system storing said consent input as part of said patient account; and
the patient consent management system presenting said consent input to at least one care giver in order to determine if said patient has given consent to a prescribed medical procedure.

11. The method of capturing consents to prescribed medical procedures according to claim 10 further comprising the steps of:
the patient consent management system presenting patient followup question input fields to patients; and
the patient consent management system storing followup question inputs entered by patients into said followup question input fields; and
the patient consent management system presenting said followup question inputs to care givers so that care givers can consult with patients regarding any concerns patients may have about prescribed medical procedure.

12. The method of capturing consents according to claim 10 wherein said step of displaying a visual representation of a prescribed medical procedure further comprises the step of the patient consent management system displaying a sequence of video clips to illustrate said prescribed medical procedure.

13. The method of capturing consents according to claim 12 further comprising the step of presenting corresponding text related to said prescribed medical procedure.

14. The method of capturing consents according to claim 12 further comprising the step of the patient consent management system maintaining a transcript indicating which video clips in the sequence were viewed and which ones were skipped by said patient.

15. The method of capturing consents according to claim 10 wherein further comprising the step of the patient consent management system recording a video showing said patient's consent to said prescribed medical procedure.

16. The method of capturing consents according to claim 10 wherein said step of presenting at least one consent request input field further comprises the step of presenting a statement field indicating the patient has witnessed and understood the visual representation of the prescribed medical procedure.

17. The method of capturing consents according to claim 10 further comprising the transmitting a message to said patient after said patient account is established, said message including a plurality of information that allow said patient to access said patient consent management system over the Internet.

18. The method of capturing consents according to claim 10 further comprising the step of said patient consent management system presenting one or more patient registration information fields for obtaining patient related registration data from said patient.

19. A patient consent management system comprising:
a first user interface providing access to a patient schedule function for scheduling prescribed medical procedures for patients;
a second user interface providing access to a login function for processing patient login attempts to patient accounts;
a computerized consent application for capturing consents from patients to prescribed medical procedures, said consent application including a first program module for simulating visual representations of prescribed medical procedures, a second program module for generating at least one consent request input field for accepting a consent input from patients, and a third program module for storing consent input received from patient; and
wherein said computerized consent application further comprises a fourth program module for presenting consent input received from patient to care giver users of said patient consent management system so that such care giver users can determine if patients have given consent to prescribed medical procedures.

20. The patient consent management system of claim 19 wherein said computerized consent application further comprises a fifth program module for presenting patient followup question input fields to patients and storing followup question input entered by patients into said followup question input fields.

21. The patient consent management system of claim 19 wherein said first program module for simulating visual representations of prescribed medical procedures further comprises software instructions for displaying a sequence of video clips to illustrate said prescribed medical procedures.

22. The patient consent management system of claim 19 wherein said computerized consent application further comprises a sixth program module for recording a video showing patient consents to prescribed medical procedure.

23. The patient consent management system of claim 19 further comprising an account setup module for transmitting messages to patients over the Internet, said messages containing account access information for accessing said second user interface over the Internet.
